(19) United States
(12) Patent Application Publication
(10) Pub. No.: US 2025/0078034 A1
(43) Pub. Date: Mar. 6, 2025

(54) SYSTEMS AND METHODS TO GENERATE UNITS OF WORK IN A COLLABORATION ENVIRONMENT

(71) Applicant: Asana, Inc., San Francisco, CA (US)

(72) Inventors: Gregory Lilley, San Francisco, CA (US); Abigail Lorean Kelly, San Francisco, CA (US); Kshitij Grover, San Jose, CA (US); Edwin Lai, San Francisco, CA (US); Rahul Jiresal, Oakland, CA (US); Sika Gasinu, Berkeley, CA (US); Nicholas Pucel, San Francisco, CA (US); Gavin Douglas, Oakland, CA (US); Allen David Chang, San Francisco, CA (US)

(21) Appl. No.: 18/956,704

(22) Filed: Nov. 22, 2024

Related U.S. Application Data
(63) Continuation of application No. 18/308,879, filed on Apr. 28, 2023.
Application No. 18/308,879 is a continuation of application No. 16/796,554, filed on Feb. 20, 2020, now Pat. No. 11,763,259.

(51) Int. Cl. G06Q 10/10; G06F 16/176; G06Q 10/101

(52) U.S. Cl. CPC G06Q 10/103; G06F 16/176; G06Q 10/101

(57) ABSTRACT

Systems and methods for generating units of work in a collaboration environment are disclosed. Exemplary implementations may: manage environment state information including work units records describing units of work assigned to individual users within the collaboration environment, individual sets of work unit records being defined by a record hierarchy, individual units of work including one or more digital content items; obtain user input information conveying user input on, or relating to, individual digital content items of the individual units of work; generate one or more work unit records based on the user input information, such that responsive to the user input information conveying first user input by a first user on, or relating to, a first digital content item, generate a second work unit record describing a second unit of work, the second work unit record being subordinate to a first work unit record; and/or perform other operations.

### FIELD OF THE DISCLOSURE

The present disclosure relates to systems and methods to generate units of work in a collaboration environment.

### BACKGROUND

Collaboration environments, sometimes referred to as integrated collaboration environments, may enable users to assign projects, tasks, or other assignments to assignees (e.g., other users) to complete. A collaboration environment may comprise an environment in which a virtual team of users does its work. A collaboration environment may enable users to work in a more organized and efficient manner. A collaboration environment may integrate features and/or functionality such as web-based conferencing and collaboration, desktop videoconferencing, and/or instant message into a single easy-to-use, intuitive interface.

### SUMMARY

One aspect of the present disclosure relates to a system configured to generate units of work in a collaboration environment. Providing comments on digital content items (e.g., images, documents, etc.) being reviewed within the context of reviewing/approving a unit of work within a collaboration environment may be difficult by virtue of having to explain what needs to be changed and referring back to certain portions of the digital content item. In some implementations, users may leave comments directly on digital content items attached to units of work. The comments may be used to generate one or more additional units of work. Individual ones of the additional units of work may include copies or versions of the digital content items, instructions to revise in accordance with the comments, and/or other information. These additional units of work may be assigned to other users to complete, promoting clarity, organization, and/or accountability within review cycles.

One or more implementations of a system to generate units of work in a collaboration environment may include one or more hardware processors configured by machine-readable instructions. Executing the machine-readable instructions may cause the one or more hardware processors to generate units of work in a collaboration environment. The machine-readable instructions may include computer program components. The computer program components may include one or more of an environment state component, an input component, a work unit component, a user interface component, and/or other components.

The environment state component may be configured to manage environment state information maintaining a collaboration environment and/or other information. The collaboration environment may be configured to facilitate interaction by users with the collaboration environment. The environment state information may include work unit records and/or other records and/or information. The work unit records may describe units of work assigned to individual users within the collaboration environment. Individual sets of work unit records may be defined by a record hierarchy. As a result, individual work unit records in the individual sets of work unit records may be subordinate to other individual work unit records in the individual sets of work unit records. Individual units of work may include one or more digital content items. By way of non-limiting illustration, the work unit records may include a first work unit record describing a first unit of work assigned to a first user, and/or other work unit records. The first unit of work may include a first digital content item.

The input component may be configured to obtain user input information and/or other information. The user input information may convey user input on, or relating to, individual digital content items of the individual units of work.

The work unit component may be configured to generate one or more work unit records based on the user input information. By way of non-limiting illustration, responsive to the user input information conveying first user input by the first user on, or relating to, the first digital content item, work unit component may be configured generate a second work unit records describing a second unit of work. The second work unit record may be subordinate to the first work unit record.

The user interface component may be configured to effectuate presentation of a user interface displaying the units of work.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to generate units of work in a collaboration environment, in accordance with one or more implementations.

FIG. 2 illustrates a method to generate units of work in a collaboration environment, in accordance with one or more implementations.

FIG. 3 illustrates a user interface, in accordance with one or more implementations.

FIG. 4 illustrates a user interface, in accordance with one or more implementations.

FIG. 5 illustrates a user interface, in accordance with one or more implementations.

### DETAILED DESCRIPTION

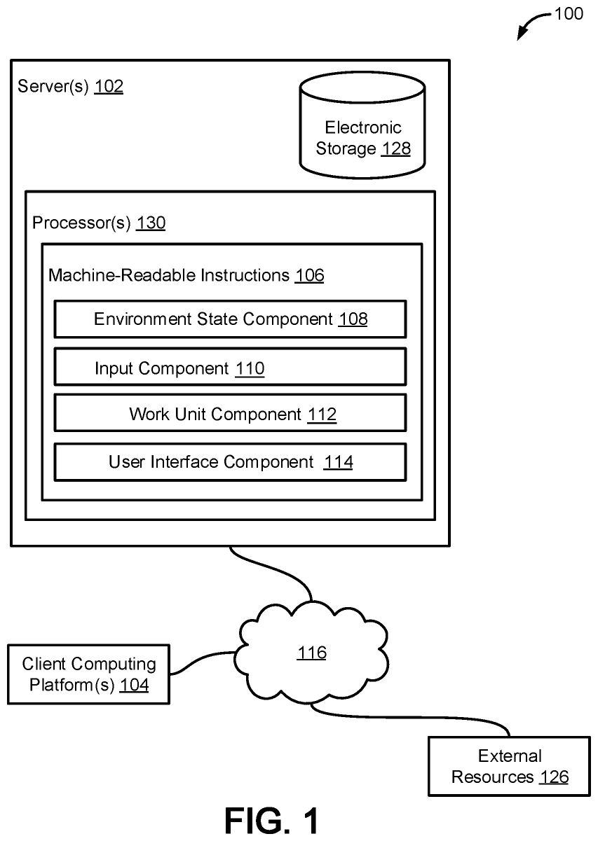

FIG. 1 illustrates a system 100 configured to generate units of work in a collaboration environment, in accordance with one or more implementations. In some implementations, users may leave comments directly on digital content items attached to units of work. The comments may be used to generate one or more additional units of work. Individual ones of the additional units of work may include copies or version of the digital content items, instructions to revise in accordance with the comments, and/or other information. These additional units of work may be assigned to other users to complete, promoting clarity, organization, and/or accountability within review cycles.

In some implementations, system 100 may include one or more of one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more of non-transitory electronic storage 128, one or more processors 130 configured by machine-readable instructions 106, and/or other components. Machine-readable instructions 106 may include one or more instruction components. The instruction components may include computer program components. Executing the machine-readable instructions 106 may cause server(s) 102 to facilitate generating units of work in a collaboration environment. The computer program components may include one or more of an environment state component 108, an input component 110, a work unit component 112, a user interface component 114, and/or other instruction components.

Environment state component 108 may be configured to manage environment state information and/or other information used in maintaining a collaboration environment. The collaboration environment may be configured to facilitate interaction by users within the collaboration environment. The environment state information may include one or more of user information, work information, and/or other information used to define, support, and/or otherwise maintain a collaboration environment.

The user information may include values of user parameters. The values of the user parameters may be organized in user records corresponding to users interacting with and/or viewing the collaboration environment. The values of the user parameters may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a group parameter, a user account, a user role information, a user department, descriptive user content, a to-email, a from-email, a photo, an organization, a workspace, one or more projects (which may include project parameters defined by one or more work unit records), one or more items of work (which may include one or more unit of work parameters defined by one or more unit of work records), one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), a presence parameter (e.g., indicating presence and/or interaction level at an environment level, unit of work level, project level, task level, application level, etc.), one or more notification settings, one or more progress parameters, status information for one or more work units the user is associated with (units of work assigned to the user, assigned to other users by the user, completed by the user, past-due date, and/or other information), one or more performance metrics of a given user (e.g., how many units of work the user has completed, how quickly the user completed the units of work, how quickly the user completes certain types of work units, the efficiency of the user, bandwidth of the user, activity level of the user, etc.), application access information (e.g., username/password for one or more third-party applications), one or more favorites and/or priorities, schedule information, and/or other information

User role information may specify individual roles of the individual users in the individual units of work. A role may represent a position of an individual user. The position may be specified based on a description of one or more of job title, level, stage, and/or other descriptions of position. The role may be specified with respect to a company as a whole, a particular unit of work, and/or other considerations. By way of non-limiting illustration, a role may include one or more of chief executive officer (or other officer), owner, manager, supervisor, accountant, associate, employee, entry level, midlevel, senior, administrator, director, foreman, engineer, product developer, human resource officer, artist, art director, and/or other description.

Schedule information for the individual users may include one or more calendar entries associated with the individual users. Individual calendar entries may be associated with the individual quantities of units of time to complete the calendar entries. The individual calendar entries may be associated with individual start dates and individual end dates.

In some implementations, schedule information may be stored locally within electronic storage 128 by virtue of features and/or functionality provided within a collaboration environment. By way of non-limiting illustration, a collaboration environment may have the features and/or functionality of calendar application configured to facilitate calendaring entries into a schedule. It is noted that schedule information may be determined through features and/or functionality provided by one or more external resources 126. By way of non-limiting illustration, an external resource may include a calendar application which may be external to a collaboration environment. The collaboration environment may have permissions to access the external calendar application to determine and/or obtain schedule information.

The work information may include values of one or more work unit parameters. The values of the work unit parameters may be organized in work unit records corresponding to units of work managed, created, and/or assigned within the collaboration environment. A given work unit may have one or more assignees and/or team members working on the given work unit. Work units may include one or more to-do items, action items, objectives, and/or other units of work one or more users should accomplish and/or plan on accomplishing. Units of work may be created by a given user for the given user and/or created by the given user and assigned to one or more other users. Individual units of work may include one or more of an individual project, an individual task, an individual sub-task, and/or other units of work assigned to and/or associated with one or more users. Individual units of work may include one or more digital content items. An individual unit of work may include an individual digital content item by virtue of the individual digital content item (and/or a copy or instance thereof) being attached and/or appended thereto. An individual unit of work may include an individual digital content item by virtue of the individual digital content item (and/or a copy or instance thereof) being accessible via the individual unit of work (e.g., via link, URL, a pointer, and/or other techniques to provide access). A digital content item may include one or more of an image, a video, an audio file, a PDF, a word document, and/or other digital content items.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access by one or more users unless and/or until a subordinate work unit record is completed and/or started. In some implementations, the work unit records may include a first work unit record describing a first unit of work assigned to a first user and/or other work unit records. The first unit of work may include a first digital content item and/or other information.

Individual work units records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information.

In some implementations, as a consequence of the record hierarchies, the individual units of work described in the individual work unit records that are subordinate to the other individual work unit records may be subordinate to the individual units of work in the other individual work unit records.

In some implementations, the one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, the units of work may be described based on one or more of a unit of work name, a unit of work description, one or more unit of work dates (e.g., a start date, a due date, a completion date, and/or dates), one or more members associated with a unit of work (e.g., an owner, one or more other project/task members, member access information, and/or other unit of work members and/or member information), a status parameter (e.g., an update, a hardcoded status update, a completed/incomplete/mark complete, a measured status, a progress indication, quantity of sub-work units remaining for a given unit of work, completed work units in a given project, and/or other status parameter), one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters.), one or more interaction parameters (e.g., indicating a given unit of work is being worked on/was worked on, given work unit of work was viewed, a given unit of work was selected, how long the given unit of work has been idle, a last interaction parameter indicating when and what user last interacted with the given unit of work, users that interacted with the given unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.), state of a workspace for a given unit of work (e.g., application state parameters, application status, application interactions, user information, and/or other parameters related to the state of the workspace for a unit of work), hierarchical information, one or more custom fields (e.g., priority, cost, stage, and/or other custom fields), and/or other information.

The values of the work assignment parameter describing units of work assigned to the individual users may be determined based on one or more interactions by one or more users with a collaboration environment. In some implementations, one or more users may create and/or assign one or more unit of work to themselves and/or an other user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date).

The input component 110 may be configured to obtain user input information and/or other information. The user input information may convey user input on, or relating to, individual digital content items of the individual units of work. In some implementations, the user input on the individual digital content items may include comments embedded on the individual digital content items. By way of non-limiting illustration, embedding a comment may be facilitated by an application program through which the digital content item may be accessed. An application program may be external to the collaboration environment and/or integrated into the collaboration environment. An application program external to the collaboration environment may be accessible by exiting (closing, minimizing, etc.) the environment and launching the application program separately. An application program integrated into the collaboration environment may be accessible within the environment and/or that access may not require leaving or exiting the environment. In some implementations, the user input relating to the individual digital content items may include text identifying the individual digital content items. By way of non-limiting illustration, a text input field within a user interface displaying a unit of work may be dedicated to providing comments. The user input relating to the individual digital content items may include text identifying the individual digital content items being input within the text input field. The digital content item may be identified by title, hyperlink, and/or a general reference to an “attached” digital content item.

In some implementations, the user input information may further include input content of the user input and/or other information. The input content may include, for example, the text of the comment input by a user. By way of non-limiting example, first user input by the first user on, or relating to, the first digital content item may include first input content.

In some implementations, environment state information may be updated as users continue to interact with the collaboration environment over time. The environment state component 108 may store and/or archive the environment state information periodically and/or based on user request to archive. In some implementations, the environment state component 108 may store historical environment state information specifying historical user information, historical work information, and/or other information.

The work unit component 112 may be configured to generate one or more work unit records based on the user input information and/or other information. Individual ones of the generated one or more units of work may include the input content of the user input included in the user input information. The generated work unit records may be specified within a record hierarchy as being subordinate to the work unit records of units of work which have received the user input. In some implementations, a generated unit of work may include the input content of the user input by virtue of the input content being specified in one or more work unit parameters of the generated unit of work. By way of non-limiting illustration, the input content may be transcribed as the unit of work description of the generated unit of work.

By way of non-limiting example, responsive to the user input information conveying the first user input by the first user on, or relating to, the first digital content item, work unit component 112 may generate a second work unit record describing a second unit of work and/or other units of work. The second work unit record may be subordinate to the first work unit record. Based on the first user input by the first user on, or relating to, the first digital content item including first input content, the second unit of work may include the first input content. In some implementations, the first input content may be transcribed into a unit of work description of the second unit of work.

In some implementations, work unit component 112 may be configured to generate the one or more work unit records based on the user input information by including one or more instances of the individual digital content items in the one or more units of work. By way of non-limiting example, the second unit of work may include an instance of the first digital content item.

In some implementations, work unit component 112 may be configured to automatically assign individual ones of the individual units of work included in the one or more work unit records generated based on the user input information to individual users who are assignors of the individual units of work which have received the user input. By way of non-limiting example, based on a second user being an assignor of the first unit of work to the first user, the second unit of work may be assigned to the second user. In some implementations, the work unit component 112 may be configured to automatically assign individual ones of the individual units of work included in the one or more work unit records generated based on the user input information to individual users of a particular roll. In some implementations, assignment may be dictated (e.g., changed from the automatic assignment, initially specified, etc.) by the assignee to other users as needed. By way of non-limiting illustration, the first user may assign the second unit of work to one or more other users as desired.

In some implementations, user interface component 114 may be configured to effectuate presentation of individual user interfaces on individual client computing platforms of one or more client computing platforms 104. The user interface component 114 may be configured to effectuate presentation of a user interface displaying the units of work. In some implementations, the user interface may display representations of the units of work in a timeline based on individual start dates and individual end dates of the individual units of work. In some implementations, the user interface may display representations of the units of work in an ordered list based on individual start dates of the individual units of work. In some implementations, representations of the units of work may include icons, graphics, and/or other elements. Selection of a representation of the units of work may facilitate generating views displaying the units of work.

The user interface may include one or more user interface elements configured to facilitate user interaction with the user interface. By way of non-limiting illustration, user interface elements may include one or more of text input fields, drop down menus, check boxes, display windows, virtual buttons, and/or other elements configured to facilitate user interaction.

A user interface may be configured to obtain user input comprising user entry and/or selection of one or more of the individual digital content items of the individual units of work, input content, and/or other information. One or more user interface elements facilitating entry and/or selection may comprise one or more text input fields, one or more check boxes, one or more drop down menus, and/or other user interface elements.

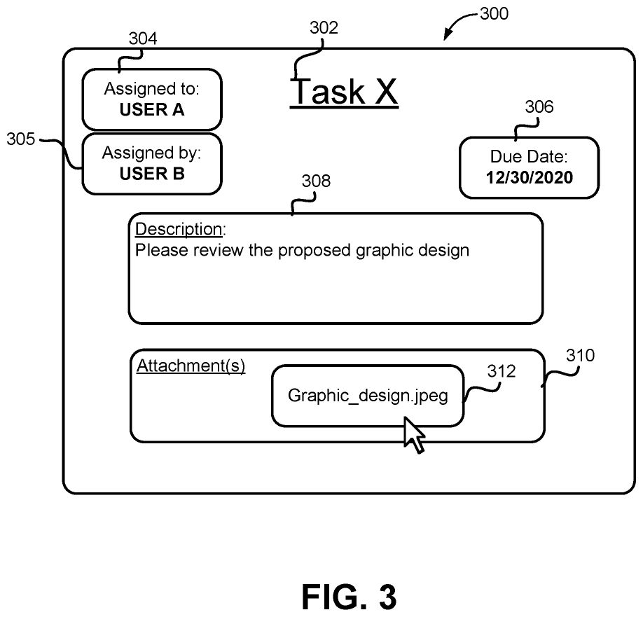

FIG. 3 illustrates a user interface 300, in accordance with one or more implementations. The user interface 300 may display a first unit of work. The user interface 300 may display different values of one or more work unit parameters of the first unit of work, and/or other information. By way of non-limiting illustration, a user interface element 302 may display a title of the first unit of work (e.g., Task X). A user interface element 304 may display an assignee of the first unit of work (e.g., User A). A user interface element 305 may display an assignor of the first unit of work (e.g., User B). A user interface element 306 may display a due date of the first unit of work. A user interface element 308 may display a unit of work description for the first unit of work. A user interface element 310 may include digital content items included in the first unit of work. By way of non-limiting illustration, a digital content item 312 may be included. Digital content item 312 may be represented in the user interface element 310 by an icon and/or graphic through which the digital content item 312 may be accessed. For illustrative purposes, the description of the unit of work may include reviewing a proposed graphic design. The digital content item 312 may include JPEG file of the proposed design graphic. A user, e.g., User A, may select the digital content item 310 to review it.

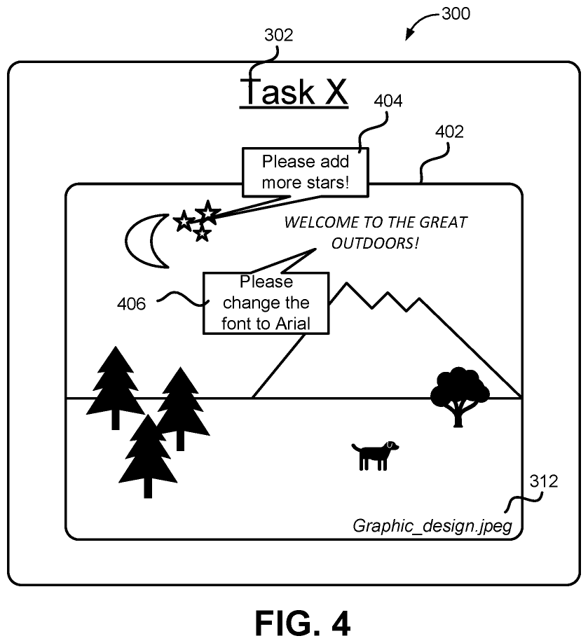

FIG. 4 illustrates user interface 300, in accordance with one or more implementations. The user interface 300 may include a view showing the digital content item 312 in a pop up window 402. The user interface 300 further shows user input on the digital content item 312. The user input may include input comprising one or more of first input content 404, second input content 406, and/or other content. The input content may be provided as comments embedded in the digital content item via, for example, comment boxes. For illustrative purpose, the first input content 404 may comprise text of “please add more stars” in relation to the part of the graphic depicting stars. The second input content 406 may comprise text of “please change the font to Arial” in relation to the part of the graphic depicting text.

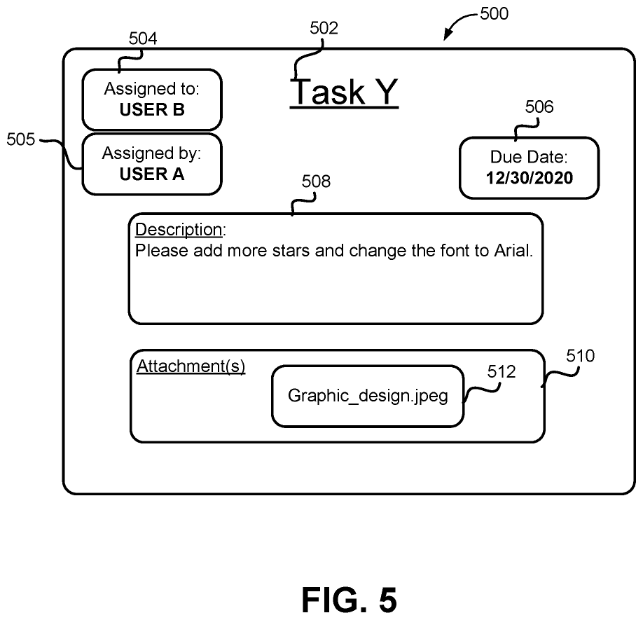

FIG. 5 illustrates a user interface 500, in accordance with one or more implementations. The user interface 500 may display a second unit of work generated based on the user input into the digital content item 312 of FIGS. 3 and/or 4. The second unit of work may be generated via a work unit record which may be specified as being subordinate to a work unit record of the first unit of work in FIG. 3. The user interface 500 may display values of one or more work unit parameters of the second unit of work, and/or other information. The one or more values may reflect the input content of FIG. 4. The assignee may be automatically set to be the assignor of the first unit of work of FIG. 3. By way of non-limiting illustration, a user interface element 502 may display a title of the second unit of work (e.g., Task Y). A user interface element 504 may display an assignee of the second unit of work (e.g., User B). A user interface element 505 may display an assignor of the second unit of work (e.g., User A). A user interface element 506 may display a due date of the second unit of work. A user interface element 508 may display a unit of work description for the second unit of work. The description may include the input content, e.g., “Please add more stars and change the font to Arial.” A user interface element 510 may include digital content items included in the second unit of work. By way of non-limiting illustration, a digital content item 512 may be included. Digital content item 512 may be represented in the user interface element 510 by an icon and/or graphic through which the digital content item 512 may be accessed. Digital content item 512 may be a copy of digital content item 312 of FIG. 3. Digital content item 512 may be a copy of digital content item 312 with the embedded user input.

It is noted that FIGS. 3-5 are for illustrative purposes only and are not to be considered limiting. Instead, it is to be understood that user interfaces may be configured in other ways and/or including other elements in accordance with one or more implementations of the system 100 presented herein.

Referring back to FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform may include one or more processors configured to execute computer program components. The computer program components may be configured to enable an expert or user associated with the given client computing platform to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, and/or other components. Processor(s) 130 may be configured to execute components 108, 110, 112, and/or 114, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 130 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 130 may be configured to execute one or more additional components that may perform some or all of the functionality attributed below to one of components 108, 110, 112, and/or 114.

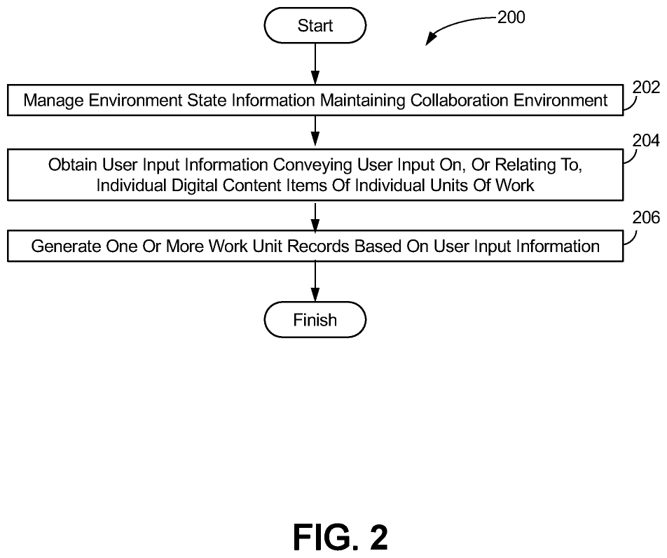

FIG. 2 illustrates a method 200 to generate units of work in a collaboration environment, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment. The collaboration environment may be configured to facilitate interaction by users with the collaboration environment. The environment state information may include work unit records describing units of work assigned to individual users within the collaboration environment. Individual sets of work unit records may be defined by a record hierarchy such that individual work unit records in the individual sets of work unit records may be subordinate to other individual work unit records in the individual sets of work unit records. Individual units of work may include one or more digital content items. By way of non-limiting illustration, the work unit records may include a first work unit record describing a first unit of work assigned to a first user. The first unit of work may include a first digital content item. Operation 202 may be performed by one or more hardware processors configured by machine-readable instructions including a component that is the same as or similar to environment state component 108, in accordance with one or more implementations.

An operation 204 may obtain user input information conveying user input on, or relating to, individual digital content items of the individual units of work. Operation 204 may be performed by one or more hardware processors configured by machine-readable instructions including a component that is the same as or similar to input component 110, in accordance with one or more implementations.

An operation 206 may generate one or more work unit records based on the user input information. Operation 206 may be performed by one or more hardware processors configured by machine-readable instructions including a component that is the same as or similar to work unit component 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to generate work unit records in a collaboration environment, the system comprising:
non-transitory electronic storage storing environment state information maintaining a collaboration environment, the environment state information including a first work unit record describing a first unit of work, the first work unit record including a digital content item expected to be reviewed in order to complete the first unit of work; and
one or more physical processors configured by machine-readable instructions to:
establish one or more network connections between a remotely located client computing platform and a server;
effectuate communication of information from the server to the remotely located client computing platform over the one or more network connections to cause the remotely located client computing platform to present an instance of a user interface of the collaboration environment, wherein the digital content item is made accessible through the user interface;
generate, at the server and responsive to obtaining user input information conveying user input on, or relating to, the digital content item through the user interface presented at the remotely located client computing platform, a second work unit record for a second unit of work, the second work unit record being subordinate to the first work unit record within a record hierarchy; and
effectuate storage of information defining the second work unit record in the non-transitory electronic storage.

2. The system of claim 1, wherein the second work unit record includes an instance of the digital content item.

3. The system of claim 1, wherein the user input includes one or more comments embedded in the digital content item.

4. The system of claim 1, wherein the user input includes text identifying the digital content item.

5. The system of claim 1, wherein the user input information further includes input content of the user input, and wherein the second work unit record is generated to include the input content.

6. The system of claim 1, wherein the one or more physical processors are further configured by the machine-readable instructions to:
identify a user as an assignor of the first work unit record; and
assign the second work unit record to the user.

7. The system of claim 1, wherein the digital content item is an image file, a video file, an audio file, or a text document.

8. The system of claim 7, wherein the digital content item is the text document.

9. The system of claim 1, wherein the user interface further displays one or more other work unit records.

10. The system of claim 9, wherein the user interface further displays the one or more other work unit records based on individual start dates and/or due dates.

11. A method to generate work unit records in a collaboration environment, the method comprising:
storing, in non-transitory electronic storage, environment state information maintaining a collaboration environment, the environment state information including a first work unit record describing a first unit of work, the first work unit record including a digital content item expected to be reviewed in order to complete the first unit of work;
establishing one or more network connections between a remotely located client computing platform and a server;
effectuating communication of information from the server to the remotely located client computing platform over the one or more network connections to cause the remotely located client computing platform to present an instance of a user interface of the collaboration environment, wherein the digital content item is made accessible through the user interface;
generating, at the server and responsive to obtaining user input information conveying user input on, or relating to, the digital content item through the user interface presented at the remotely located client computing platform, a second work unit record for a second unit of work, the second work unit record being subordinate to the first work unit record within a record hierarchy; and
effectuating storage of information defining the second work unit record in the non-transitory electronic storage.

12. The method of claim 11, wherein the second work unit record includes an instance of the digital content item.

13. The method of claim 11, wherein the user input includes one or more comments embedded in the digital content item.

14. The method of claim 11, wherein the user input includes text identifying the digital content item.

15. The method of claim 11, wherein the user input information further includes input content of the user input, and wherein the second work unit record is generated to include the input content.

16. The method of claim 11, further comprising:
identifying a user as an assignor of the first work unit record; and
assigning the second work unit record to the user.

17. The method of claim 11, wherein the digital content item is an image file, a video file, an audio file, or a text document.

18. The method of claim 17, wherein the digital content item is the text document.

19. The method of claim 11, wherein the user interface further displays one or more other work unit records.

20. The method of claim 19, wherein the user interface further displays the one or more other work unit records based on individual start dates and/or due dates.
